(19) United States
(12) Patent Application Publication
(10) Pub. No.: US 2013/0268413 A1
(43) Pub. Date: Oct. 10, 2013

(54) Methods and Systems for Exchanging Stored Value Using a Mobile Communication Device

(71) Applicants: Busy Burr, Menlo Park, CA (US); Sam Lising, San Francisco, CA (US)

(72) Inventors: Busy Burr, Menlo Park, CA (US); Sam Lising, San Francisco, CA (US)

(73) Assignee: Citi Ventures, Inc., Palo Alto, CA (US)

(21) Appl. No.: 13/443,153

(22) Filed: Apr. 10, 2012

(51) Int. Cl. G06Q 30/06

(52) U.S. Cl. 705/27.1; 705/26.1

(57) ABSTRACT

Methods and systems for exchanging stored value for shopping at a vendor using a mobile device involve identifying, by an application on the mobile device, a vendor for a user's shopping. Information regarding a trade of stored value of the user issued by at least one other vendor in exchange for stored value issued by the vendor for shopping by the user is retrieved by the application, and at least a portion of the stored value of the user issued by the at least one other vendor is identified by the application to exchange for stored value issued by the vendor for shopping by the user. Thereafter, the stored value issued by the vendor for shopping by the user is received by the application in exchange for at least a portion of the stored value of the user issued by the at least one other vendor.

### FIELD OF THE INVENTION

The present invention relates generally to the field of electronic financial transactions, and more particularly to methods and systems for exchanging stored value for shopping at a vendor using a mobile communication device.

### BACKGROUND OF THE INVENTION

A concept which may be referred to as the alternative currency space presently exists in the marketplace. An aspect of the alternative currency space is that a significant amount of a stored value type of non-cash currency is owned by people which is not actually cash or money. Examples of such non-cash stored value include, without limitation, loyalty points, pre-paid telephone minutes, virtual currencies (e.g., FACEBOOK® credits), and gift cards. There is currently considerable activity in this alternative currency space from a technological standpoint that is directed to attempting to make it easier for people to transact with these types of non-cash currencies.

Most of such activity has involved the creation of various exchanges that allow people who own such non-cash stored value that is usable with one vendor to trade it for other non-cash stored value that is usable with a different vendor. For example, a person may use such an exchange to trade his or her rewards points that are redeemable for travel on one airline for rewards points that are redeemable for travel on a different airline. For another example, a person may likewise use such an exchange to trade a gift card usable at one vendor for a gift card usable at a different vendor. In the past, entities that provide these types of exchange services have made virtually no attempt to deal with the lack of a good customer experience that results from the feeling of loss which the user may experience when viewing the details of an exchange transaction including the amount which the customer loses in the exchange.

There is a present need for methods and systems for exchanging stored value for shopping at a vendor using a mobile communication device that provides a good customer experience which does not require a user to observe all the details of a gift card exchange transaction including the unpleasant experience of seeing the amount which the user is losing in the exchange of gift cards, but instead simply displays transparently for the user a total amount of what all the user's gift cards, including the gift cards from other retailers, are presently worth in the particular retail store in which the user is shopping.

These and other aspects of the invention will be set forth in part in the description which follows and in part will become more apparent to those skilled in the art upon examination of the following or may be learned from practice of the invention. It is intended that all such aspects are to be included within this description, are to be within the scope of the present invention, and are to be protected by the accompanying claims.

### SUMMARY OF THE INVENTION

Embodiments of the invention employ computer hardware and software, including, without limitation, one or more processors coupled to memory and non-transitory computer-readable storage media with one or more executable programs stored thereon which instruct the processors to perform the methods and systems for exchanging stored value for shopping at a vendor using a mobile communication device described herein.

Embodiments of the invention may provide methods for exchanging stored value for shopping at a vendor using a mobile communication device that involve, for example, identifying, using an application on a microprocessor of the mobile computing device, a vendor for shopping by a user; retrieving, using the application on the mobile computing device microprocessor, information regarding a trade of stored value of the user issued by at least one other vendor in exchange for stored value issued by the vendor for shopping by the user; identifying, using the application on the microprocessor of the mobile computing device, at least a portion of the stored value of the user issued by the at least one other vendor to exchange for stored value issued by the vendor for shopping by the user; and receiving, using the application on the microprocessor of the mobile computing device, the stored value issued by the vendor for shopping by the user in exchange for at least a portion of the stored value of the user issued by the at least one other vendor.

In an aspect of embodiments of the invention, identifying the vendor for shopping by the user may involve identifying, by the application, the vendor for shopping by the user using a user-locator function of the mobile computing device. In another aspect, identifying the vendor for shopping by the user using the user-locator function may involve identifying, by the application, the vendor for shopping by the user using the user-locator of the mobile computing device in communication with a vendor location database at a time when the mobile computing device is located at a premises of the vendor for shopping by the user. The user-locator function may comprise a global positioning system function of the mobile computing device, but it is to be understood that the user locator function is not limited to a global positioning function and may comprise any other real time user location technology. In a further aspect, identifying the vendor for shopping by the user may involve receiving entry, by the application, of a selection of the vendor for shopping by the user. In an additional aspect of embodiments of the invention, receiving entry by the application of the selection of the vendor for shopping by the user may involve receiving entry by the application of the selection of the vendor for shopping by the user from a list of pre-designated preferred vendors of the user for shopping by the user. The application may be both web enabled and mobile enabled, and the mobile computing device may be a mobile communication device, such as a mobile phone.

In a still further aspect of embodiments of the invention, retrieving the information may involve retrieving the information regarding the trade of stored value of the user issued by the at least one other vendor in exchange for stored value issued by the vendor for shopping by the user from a stored value exchange service. In another aspect, retrieving the information regarding the trade of stored value of the user may involve retrieving the information regarding the trade of stored value of the user issued by a plurality of other vendors in exchange for stored value issued by the vendor for shopping by the user. In a further aspect, retrieving the information regarding the trade of stored value of the user issued by the at least one other vendor may involve retrieving information regarding a trade of at least one of a gift card, a prepaid card, or rewards points of the user issued by the at least one other vendor in exchange for stored value issued by the vendor for shopping by the user.

In another aspect of embodiments of the invention, retrieving the information regarding the trade of stored value of the user issued by the at least one other vendor may involve retrieving at least a user's account identifier and a vendor's identifier with respect to the stored value of the user issued by the at least one other vendor. In still another aspect, retrieving the information regarding the trade of stored value of the user issued by the at least one other vendor may involve retrieving a spend value of the stored value of the user issued by the at least one other vendor in an exchange for the stored value issued by the vendor for shopping by the user. In a further aspect, retrieving the spend value of the stored value of the user may involve retrieving a total spend value of the stored value of the user issued by a plurality of other vendors in an exchange for the stored value issued by the vendor for shopping by the user.

In an additional aspect of embodiments of the invention, identifying at least a portion of the stored value of the user issued by the at least one other vendor to exchange may involve displaying on the mobile computing device a total spend value of the stored value of the user issued by a plurality of other vendors prioritized in a pre-determined order for an exchange. In a further aspect, displaying the total spend value of the stored value of the user issued by the plurality of other vendors prioritized in the pre-determined order may involve displaying on the mobile computing device the total spend value of the stored value of the user issued by the plurality of other vendors prioritized according to an exchange rate of each stored value in an exchange. In further aspects, displaying the total spend value of the stored value of the user issued by the plurality of other vendors prioritized in the pre-determined order may involve displaying on the mobile computing device the total spend value of the stored value of the user issued by the plurality of other vendors prioritized according to an exchange value of each stored value in an exchange.

In additional aspects of embodiments of the invention, displaying the total spend value of the stored value of the user issued by the plurality of other vendors prioritized in the pre-determined order may involve displaying on the mobile computing device the total spend value of the stored value of the user issued by the plurality of other vendors prioritized according to a spend value of each stored value in an exchange. In other aspects, displaying the total spend value of the stored value of the user issued by the plurality of other vendors prioritized in the pre-determined order may involve displaying on the mobile computing device the total spend value of the stored value of the user issued by the plurality of other vendors prioritized according to identification of each of the plurality of other vendors.

In other aspects of embodiments of the invention, receiving the stored value issued by the vendor for shopping by the user may involve initiating via an exchange service a trade of at least a portion of the stored value of the user issued by at least one other vendor in exchange for the stored value issued by the vendor for shopping by the user. In further aspects, receiving the stored value issued by the vendor for shopping by the user may involve displaying on the mobile computing device an identifier for the stored value issued by the vendor for shopping by the user. In still other aspects, displaying the identifier may involve displaying on the mobile computing device a scannable code for the stored value issued by the vendor for shopping by the user.

Other embodiments of the invention may provide systems for exchanging stored value for shopping at a vendor using a mobile computing device that employ a mobile computing device processor coupled to memory, which mobile computing device processor is programmed for identifying, by an application on the mobile computing device, a vendor for a user's shopping; retrieving, by the application, information regarding a trade of stored value of the user issued by at least one other vendor in exchange for stored value issued by the vendor for shopping by the user; identifying, by the application, at least a portion of the stored value of the user issued by the at least one other vendor to exchange for stored value issued by the vendor for shopping by the user; and receiving, by the application, the stored value issued by the vendor for shopping by the user in exchange for at least a portion of the stored value of the user issued by the at least one other vendor.

Further aspects of embodiments of the invention may involve, for example, a method and/or system of retrieving stored value for shopping at a vendor. Such aspect may involve, for example, identifying, using a mobile computing device having a microprocessor, by a user-locator function of the mobile computing device a vendor for shopping by the user. Using the mobile computing device, stored value of the user redeemable at the vendor for shopping by the user may be retrieved by an application on the mobile computing device of the user and displayed for the user by the application likewise using the mobile computing device.

These and other aspects of the invention will be set forth in part in the description which follows and in part will become more apparent to those skilled in the art upon examination of the following or may be learned from practice of the invention. It is intended that all such aspects are to be included within this description, are to be within the scope of the present invention, and are to be protected by the accompanying claims.

### BRIEF DESCRIPTION OF THE DRAWINGS

FIG. 1 is a schematic diagram that shows an example of key components and the flow if information between key components for an aspect of embodiments of the invention;

FIG. 2 is a flow chart that illustrates an example of the process of downloading a mobile application and setting up a new account and location services using the application for embodiments of the invention;

FIG. 3 is a flow chart that illustrates an example of the process of checking out while shopping at a local preferred vendor using the application for embodiments of the invention; and

FIG. 4 is a flow chart that illustrates an example of the process of exchanging stored value for shopping at a vendor using the application for embodiments of the invention on a mobile computing device having a microprocessor.

### DETAILED DESCRIPTION

Reference will now be made in detail to embodiments of the invention, one or more examples of which are illustrated in the accompanying drawings. Each example is provided by way of explanation of the invention, not as a limitation of the invention. It will be apparent to those skilled in the art that various modifications and variations can be made in the present invention without departing from the scope or spirit of the invention. For example, features illustrated or described as part of one embodiment can be used in another embodiment to yield a still further embodiment. Thus, it is intended that the present invention cover such modifications and variations that come within the scope of the invention.

Embodiments of the invention utilize, for example, an application such as a mobile application, that allows a user to trade non-cash stored value at a time when the user wants to pay for a purchase, such as when the user is at a vendor's premises. Thus, if a user shopping in a particular retail store has a gift card from another retail store, the user can simply access his or her wallet application on the user's mobile computing device, such as a smart phone or other mobile device, and exchange the gift card from the other retail store for a gift card from the particular retail store in which he or she is shopping. Once the user performs the exchange, he or she can then check out at the point of sale in the particular store and pay for purchases fully or partly with the gift card from the particular store.

A challenge for applications that allow such exchanges is that most people who access an application, for example, to exchange a gift card from one vendor for a gift card from another vendor experience a financial loss in the exchange. For example, a user may find that a gift card worth $50 from one vendor can only be exchanged for a gift card worth $40 from another vendor because the exchange takes a cut or spread from the exchange transaction. Thus, the user who is shopping in the particular store and exchanges his or her gift card from another retail store for a gift card from the particular retail store may experience a loss of $10 in the exchange process, which is not a good customer experience.

In the past, entities that provide these types of exchange services have made virtually no attempt to deal with the lack of a good customer experience resulting from a feeling of loss which the user experiences. Instead, such entities have focused almost entirely on the exchange process itself. Embodiments of the invention focus on a customer oriented insight that a primary objective of someone who has a gift card is not to engage in an exchange of gift cards per se, but it is instead simply to buy something with the value represented by the gift cards. According to this insight, when a user in in a particular retail store, the user wants to be able to open up his or her mobile device wallet application and immediately see how much money he or she has available to make purchases.

Thus, in embodiments of the invention, when a user who is shopping in a particular retail store opens his or her mobile wallet application, the user is immediately presented with a total spend value of every gift card which the user has in his or her mobile wallet if all of the gift cards from other vendors were exchanged for a gift card from the particular retail store. Instead of requiring the user who is shopping in the particular retail store to decide, for example, which gift card or cards from other retailers the user does or does not to want to exchange and to manually enter an exchange transaction, the mobile wallet application for embodiments of the invention displays transparently for the user a total amount of what all the user's gift cards, including gift cards from other retailers, are presently worth in the particular retail store in which the user is shopping.

An aspect of embodiments of the invention employs global positioning system functionality of the mobile device to identify a location of the user, such as a particular retail store location in which the user's mobile device is located and in which the user is presumably likewise located. In an alternative aspect, the user may enter his or her location, such as the identification and location of a particular retail store, on the user's mobile wallet application. Thus, as previously noted, when the user opens his or her mobile wallet application, the user is immediately presented with the total spend value of every gift card which the user has in his or her mobile wallet if all of the gift cards from other vendors were exchanged for a gift card from the particular retail store.

A key aspect of embodiments of the invention is providing a good customer experience. Such an experience does not require the user to observe the details of the gift card exchange transaction, including the likely disappointment in seeing the amount which the user is losing in the exchange of gift cards. Thus, embodiments of the invention instead involve transparently displaying for the user a total amount of what all of the user's gift cards, including the gift cards from other retailers, are presently worth in the particular retail store in which the user is shopping. Even though an exchange transaction may actually occur with the loss of a cut or spread on the exchange, embodiments of the invention eliminate the necessity of the user actually engaging in the transaction, for example, by entering a selection to exchange particular gift cards and having the details of the cut or spread on the exchange displayed for the user.

On the other hand, if the user wishes to drill down and actually see the details of the exchange transaction, including the amount of the user's loss via the cut or spread, embodiments of the invention allow the user to do that. However, judging from what happens when people traveling in foreign countries need to convert U.S. dollars to foreign currency, that is not likely to happen. Such people do not typically go from one exchange desk to another inquiring about exchange rates. Instead, they simply approach, for example, an ATM machine, insert their ATM card, and retrieve the foreign currency that they requested without going through a great deal of details about the exchange, which is the good customer experience most people want to have.

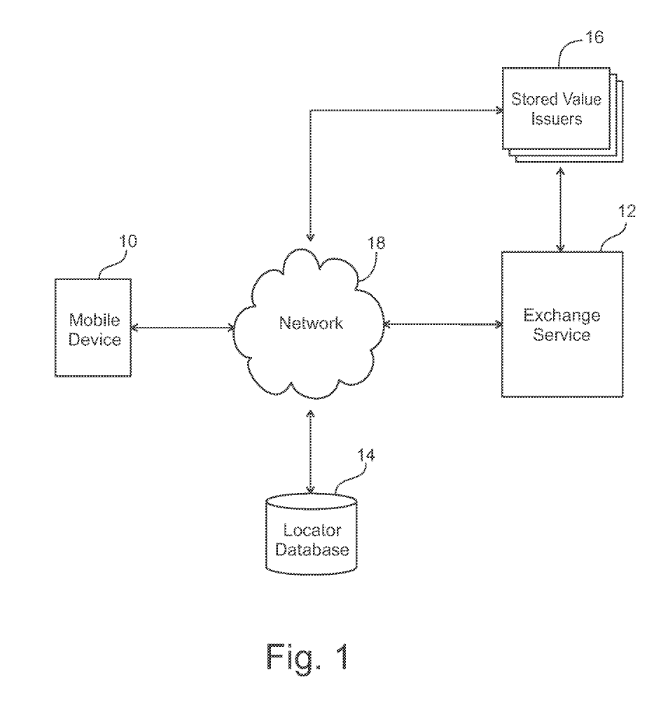

FIG. 1 is a schematic diagram that shows an example of key components and the flow if information between key components for an aspect of embodiments of the invention. Referring to FIG. 1, embodiments of the invention may employ, for example, a microprocessor of a mobile computing device 10, such as a user's mobile phone, an exchange service processor 12, a locator database 14, and processors of one or more stored value issuers 16, which may be in communication via a network 18. In embodiments of the invention, a user may acquire a mobile application and set up a new account and location services in the application. The mobile application may be downloaded to the user's mobile device 10, such as a mobile communications device or mobile phone.

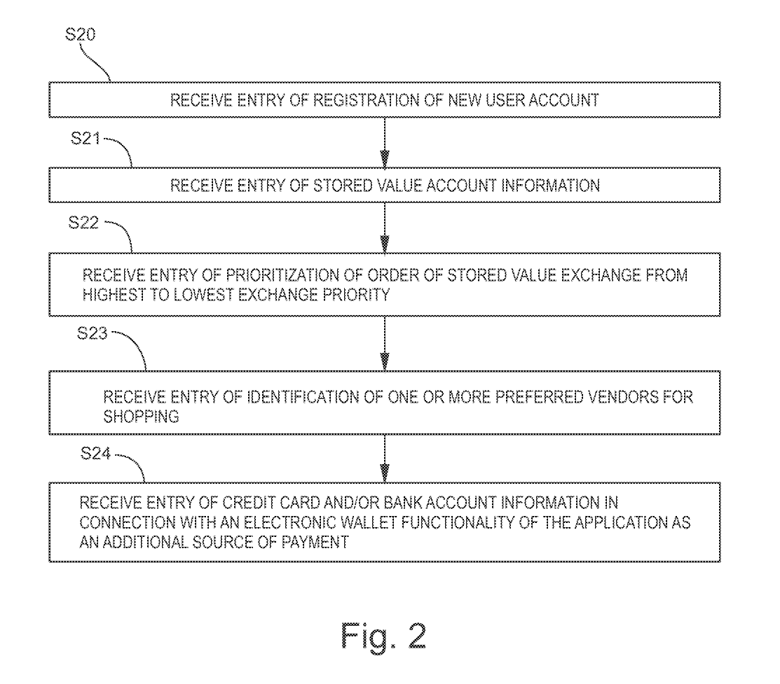

FIG. 2 is a flow chart that illustrates an example of the process of downloading a mobile application and setting up a new account and location services using the application for embodiments of the invention. Referring to FIG. 2, in embodiments of the invention, the user may register a new user account at S20. The mobile application may be both web enabled and mobile enabled. Web enabled functionality of embodiments of the invention may allow the user to input stored value account information, such as the user's gift cards, prepaid cards, rewards points and the like to the mobile application which may also function as a mobile wallet application. According to embodiments of the invention, at S21, the user may input his or her stored value account information to the mobile application via the web or enter it on the mobile device 10. The stored value information may include, for example, a vendor's identification and the user's account identifier with the vendor, such as the user's account number.

Based on the stored value information that is entered on the mobile application, the application may retrieve a balance of the user's stored value with each vendor. According to embodiments of the invention, it is not necessary for vendors to be participating members. For example, there are typically a small number of gift card processors that process most vendors' gift cards. Thus, a gift card exchange service, such as exchange service 12, that has a relationship with one or more gift card processors is likely to have access to most vendors that offer gift cards, such as stored value issuers 16. In embodiments of the invention, the mobile application may go directly to a user's stored value account, such as a rewards account, with a stored value issuer 16 and access the stored value account balance of the user.

In a prioritizing aspect of embodiments of the invention, the user may be prompted by the mobile application to prioritize a user-preferred order of stored value exchange. In the prioritizing aspect, at S22, the user may prioritize the order of stored value exchange from highest to lowest exchange value or from most favorable to least favorable exchange rate or from the user's least favorite vendor for shopping to the user's most favorite vendor for shopping. The user may have a vendor's gift card with respect to which the user may lose, for example, twenty percent on an exchange transaction and another vendor's gift card with respect to which the user may lose only five percent on the exchange transaction. In the prioritizing aspect, the user may ask the mobile application to display the exchange value of the user's gift card or cards with respect to which the exchange rate (i.e., the amount charged by the exchange service for the exchange transaction) is the most favorable first. Alternatively, the user may ask the mobile application to display the exchange value of the user's gift card or cards from the vendor or vendors which the user considers to be his or her least favorite for shopping first. On the other hand, the user may ask the mobile application to display the exchange value of the user's gift card or cards in order of the amount of stored value on each gift card.

In a preferred vendor aspect of embodiments of the invention, in response to a prompt by the mobile application, at S23, the user to enter an identification of one or more of the user's preferred vendors for shopping. Thus, the user's preferred gift cards for shopping are displayed by the mobile application first when the user is checking out and paying for purchases. As previously noted, a global positioning system (GPS) aspect of embodiments of the invention employs a GPS functionality of the user's mobile device 10 to identify a particular vendor in whose store the user is presumably shopping. Thus, using the GPS function to determine the user's location in a particular vendor's store, the mobile application for embodiments of the invention may display the user's gift card or cards from the particular vendor. Likewise using the GPS function to determine the user's location in a particular vendor's store, the mobile application may display the exchange value of the user's stored value from various other vendors in the particular vendor's store. The user may either use his or her gift card or cards from a particular vendor's store in which the user is shopping as identified by the GPS function of the user's mobile device 10 to pay for goods purchased in the store or may elect to exchange one or more gift cards, loyalty points, such as airline points, or the like from other vendors to pay for the goods purchased in the particular store.

A non-GPS alternative of the preferred vendor aspect may allow a user to enter several of the user's favorite vendors in advance and simply click on an icon to select one of the favorite vendors in response to which the mobile application may display the exchange value of the user's stored value from various other vendors in the selected vendor's store. This aspect enables the user to select the particular favorite vendor with a click rather than having to type in a name for the vendor.

In an additional payments aspect of embodiments of the invention, in response to a prompt by the mobile application on the user's mobile device 10, at S24, the user may enter credit card and/or bank account information in connection with an electronic wallet functionality of the application for making payments not covered, for example, by stored value.

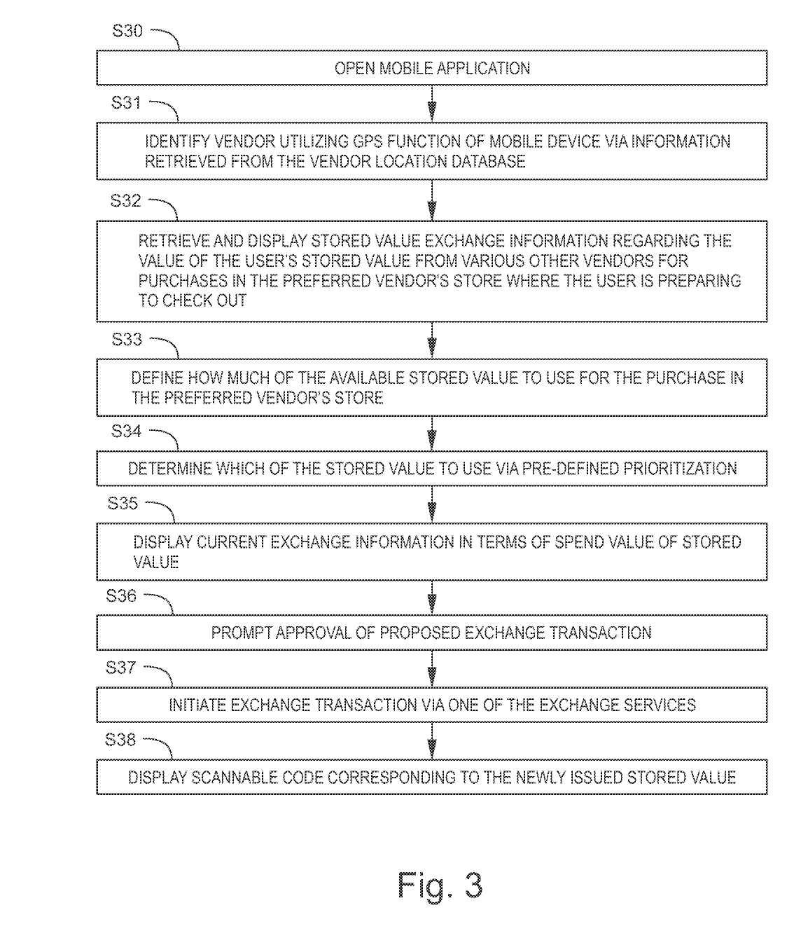

FIG. 3 is a flow chart that illustrates an example of the process of checking out while shopping at a local preferred vendor using the application for embodiments of the invention. Once a user has downloaded the mobile application for embodiments of the invention to the user's mobile device 10, such as the user's mobile phone, and has entered the foregoing information and is shopping at one of the user's local preferred vendors, the user may utilize the mobile application, for example, when the user is ready to check out and pay for his or her purchases. Referring to FIG. 3, at the checkout counter, the user may click on an icon on the user's mobile device 10 to open the mobile application at S30, and the mobile application may utilize the GPS function of the mobile device 10 to identify the vendor via information retrieved from the vendor location database 14 at S31.

The mobile application may then display the identification of the particular vendor on the user's mobile device 10 for the user. Referring further to FIG. 3, at S32, the mobile application may also retrieve and display the stored value exchange information regarding the value of the user's stored value from various other vendors for purchases in the particular vendor's store where the user is preparing to check out. Thus, the mobile application may display for the user the dollar value of the user's stored value from all vendors in the user's stored value account available for paying for purchases in the particular vendor's store.

In embodiments of the invention, the amount displayed by the mobile application for the user on the user's mobile device 10 may be the net amount available for paying for purchases in the particular vendor's store without details of any discounts or similar deductions taken, for example, by the exchange service 12. As previously noted, some vendors' gift cards having a particular face value may be worth more in an exchange transaction than other vendors' gift cards having the same face value because of various factors, such as availability and/or popularity of different vendors' stores for shopping which may affect the relative demand for such gift cards.

The user may view the total available stored value total displayed by the mobile application on the user's device 10, and at S33, the user may define how much of the available stored value he or she wishes to use for the purchase in the particular vendor's store. For example, the user may elect to use all or a portion of the displayed stored value to pay all or a portion of the purchase price in the particular vendor's store. The user may simply click an icon to accept or decline an exchange transaction, and the user may enter a particular amount of the stored value to apply to the purchase price.

According to embodiments of the invention, the user may elect how much of the user's stored value account to use for the purchase. Referring further to FIG. 3, at S34, the mobile application may determine which gift cards, for example, in the user's stored value account to use according to the user-defined prioritization. Thus, the user may determine what amount of stored value to use, if any, and the mobile application may determine which of the user's stored value to use to fulfill that amount. If the user prioritized his or her stored value from highest exchange value to lowest exchange value, the mobile application may determine to use the user's stored value with the highest exchange value first. The user may opt not to use the stored value with the highest exchange value and direct the mobile application to display the user's stored value, for example, with the next lower exchange value or another of the user's stored value, depending on the user's previously entered prioritization preference. The user may accept or decline the use of the first stored value displayed by the mobile application, and may likewise accept or decline other stored value displayed by the mobile application in the order of the user's previously entered preference.

Referring again to FIG. 3, according to embodiments of the invention, at S35, the mobile application may display for the user on the user's mobile device 10 current exchange information in terms, for example, of the spend value at the particular vendor's store of another vendor's gift card having a particular face value which, as previously explained, may generally be less than the face value in an exchange transaction. At S36, the user may be prompted by the mobile application to enter an approval or decline of the proposed exchange transaction. If the user enters an approval, in the background, pursuant to the user's selections, at S37, the user's mobile application may initiate the user's selected exchange transaction via one of the exchange services 12 previously described, whereupon a new gift card from the vendor in whose store the user is shopping may be issued for the user in exchange for other of the user's stored value.

Referring once more to FIG. 3, at S38, the mobile application may then display a scannable code, such as a QR code, a UPC code, a bar code, or any other suitable scannable code on the display screen of the user's mobile device 10 corresponding to the newly issued gift card. The displayed code may then be scanned using a vendor's scannable code reader at the vendor's store checkout in a known way in which vendors typically scan other digital or electronic gift cards. The user's newly issued gift card may be validated and the payment transaction accepted by the vendor.

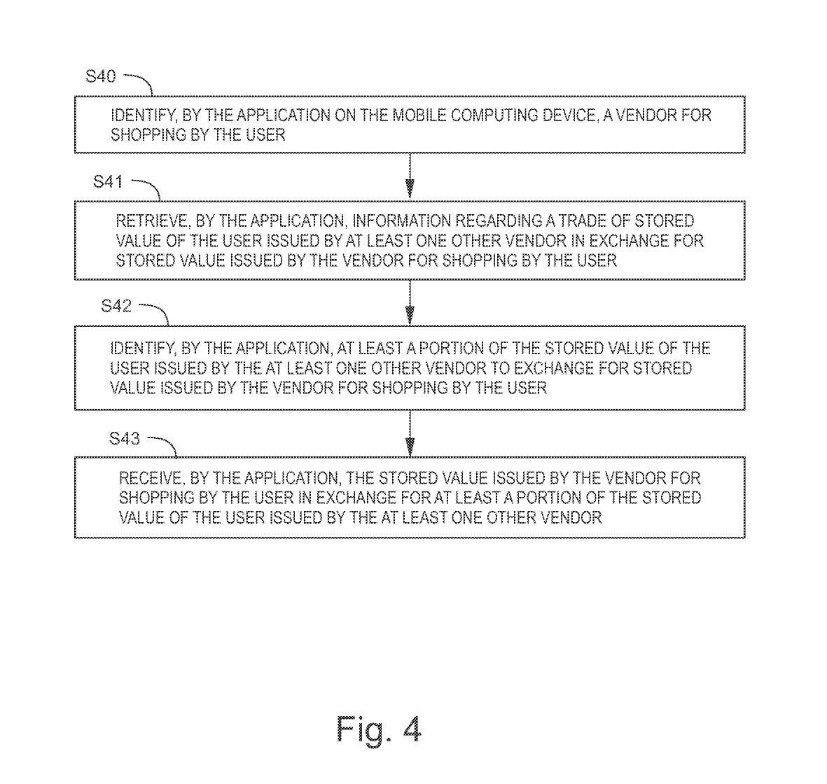

FIG. 4 is a flow chart that illustrates an example of the process of exchanging stored value for shopping at a vendor using the application for embodiments of the invention on a mobile computing device having a microprocessor. Referring to FIG. 4, at S40, a vendor for shopping by the user may be identified by the application on the user's mobile computing device 10, such as the user's mobile phone. At S41, information regarding a trade of stored value of the user issued by at least one other vendor in exchange for stored value issued by the vendor for shopping by the user may be retrieved by the application on the user's mobile device 10. At S42, at least a portion of the stored value of the user issued by the at least one other vendor to exchange for stored value issued by the vendor for shopping by the user may be identified by the application on the user's mobile device 10. At S43, the stored value issued by the vendor for shopping by the user in exchange for at least a portion of the stored value of the user issued by the at least one other vendor may be received by the application on the user's mobile device 10.

The following is an example of a manner in which a user may set up and use the mobile application for embodiments of the invention on the user's mobile computing device, such as the user's mobile phone. Initially, the user may download the mobile application to the user's mobile phone. It is to be noted that while this example employs a mobile phone, the present invention is not limited to deployment of the mobile application on a mobile phone and that embodiments of the invention may use any suitable mobile computing device. Upon the first launch of the application, the user is presented with an overview of what the application provides. The overview may be in the form of a message displayed on the display screen of the user's mobile phone, such as “Marketplace™ allows you to make purchases using gift cards, prepaid cards and credit cards of any origin for things you really want and at the stores in which you prefer to shop”. Upon clicking on a “Next” button which may be displayed on the display screen of the user's mobile phone, the user may be prompted to complete the application set-up. At this point, the user may be prompted enter a name and password in entry fields displayed on the screen

Thereafter, upon clicking on another “Next” button displayed on the screen, the user may be prompted to enter all of the user's cards. The card entry process may involve the user clicking on a “Choose card type” button and being prompted to enter a selection of a card type from a dropdown list of different types of cards, such as a gift card, a prepaid card, and/or a credit card. The user may click on a particular type of card on the dropdown list, whereupon appropriate entry fields may be displayed for the user to enter a card issuer and a card number. The user may enter the card issuer and corresponding card number for a first of the user's cards. The user may then click on an “Add another card” button, whereupon the process may be repeated for each different gift card, prepaid card, and/or credit card of the user. It is to be understood that the present invention is not limited to entering information about gift cards, prepaid card, and credit cards but also includes entry of information about any and all types of stored value.

In the foregoing example, assume that the user may have entered three prepaid cards and four gift cards for a total of seven different cards. Again, the invention is not limited to entry of card information but may include entry of information about any type of stored value. Having entered all of the user's cards, the user may click on a “Next” button and be presented with an option to establish a priority of use for the users' cards. Thus, the user may be presented with a message, such as “Drag cards to prioritize them for order of use or press ‘By Highest Exchange’” on the display screen of the user's mobile phone. The user may then complete the process of re-ordering the user's cards by dragging the cards according to the user's priority preferences or simply clicking on “By Highest Exchange”.

Thereafter, the user may again click on a “Next” button and be prompted to enter the user's preferred vendors and stores on appropriate text entry fields. Assume that the user enters four of the user's favorite stores. The user may then click on another “Next” button and be prompted to add bank and credit card information. At that point the user may enter a bank name and account number on text entry fields displayed for bank information. The user may also select a type of credit card from a dropdown list of credit card types and enter credit card account number on an appropriate text entry field. The user may repeat either of those processes for other bank or credit card information. When finished, the user may click on a “Done” button, and the set-up of the mobile application for embodiments of the invention on the user's mobile phone is complete.

Continuing with the example, in the aspect of using the mobile application for embodiments of the invention, the user may open the application on the user's mobile phone while shopping at a particular retailer's store. When opened, the application may search for the user's location using the global positioning system function of the user's mobile phone and a retailer location database to identify the retailer. Upon identifying the retailer, the application may retrieve the exchange information between the particular retailer and all of the user's stored value accounts. As an alternative to use of the global positioning function the user may simply go to the user's favorite stores screen and click on the particular retailer's store. If the particular retailer's store is not already entered, the user may add the particular store to the user's favorite store in the manner previously described.

Assume for this example that the total exchange value of all of the user's stored value at the particular retailer is $48.52. The application may present a message on the display screen of the user's mobile phone, such as the name of the retailer followed by “$48.52 in value” and may prompt the user to enter the amount of that value which the user wants to use. The user may define how much stored value to use for the purchase and may choose to use all or a portion of the stored value for the purchase. The user may elect to use $40 of the stored value for the purchase in the present example by entering an amount of $40 on a displayed entry field. Thereafter, when the user clicks on an “OK” button, the application may determine which stored value accounts to use based upon the user's pre-defined prioritized list setting.

The application may then display the current stored value exchange information as applied to the purchase amount. In the present example, assume that the total purchase amount is $124.45. Accordingly, the application may display a purchase amount of $124.25 and a stored value amount of $40, with a balance, such as a balance of $84.45 to be charged to a credit card account. The application may also prompt the user for approval. If the user enters an approval by clicking on an “OK” button, the application may then display a code, such as a barcode, on the display screen of the user's mobile phone. The user may then present the user's mobile phone to the retailer who may scan the code and authorize the transaction for the user. As previously noted, the preceding example of the manner in which a user may set up and use the mobile application for embodiments of the invention on the user's mobile computing device, as well as every other example presented herein, is provided by way of explanation of the invention and not as a limitation of the invention

It is to be understood that embodiments of the invention may be implemented as processes of a computer program product, each process of which is operable on one or more processors either alone on a single physical platform, such as a personal computer, or across a plurality of platforms, such as a system or network, including networks such as the Internet, an intranet, a WAN, a LAN, a cellular network, or any other suitable network. Embodiments of the invention may employ client devices that may each comprise a computer-readable medium, including but not limited to, random access memory (RAM) coupled to a processor. The processor may execute computer-executable program instructions stored in memory. Such processors may include, but are not limited to, a microprocessor, an application specific integrated circuit (ASIC), and or state machines. Such processors may comprise, or may be in communication with, media, such as computer-readable media, which stores instructions that, when executed by the processor, cause the processor to perform one or more of the steps described herein.

It is also to be understood that such computer-readable media may include, but are not limited to, electronic, optical, magnetic, RFID, or other storage or transmission device capable of providing a processor with computer-readable instructions. Other examples of suitable media include, but are not limited to, CD-ROM, DVD, magnetic disk, memory chip, ROM, RAM, ASIC, a configured processor, optical media, magnetic media, or any other suitable medium from which a computer processor can read instructions. Embodiments of the invention may employ other forms of such computer-readable media to transmit or carry instructions to a computer, including a router, private or public network, or other transmission device or channel, both wired or wireless. Such instructions may comprise code from any suitable computer programming language including, without limitation, C, C++, C#, Visual Basic, Java, Python, Perl, and JavaScript.

It is to be further understood that client devices that may be employed by embodiments of the invention may also comprise a number of external or internal devices, such as a mouse, a CD-ROM, DVD, keyboard, display, or other input or output devices. In general such client devices may be any suitable type of processor-based platform that is connected to a network and that interacts with one or more application programs and may operate on any suitable operating system. Server devices may also be coupled to the network and, similarly to client devices, such server devices may comprise a processor coupled to a computer-readable medium, such as a random access memory (RAM). Such server devices, which may be a single computer system, may also be implemented as a network of computer processors. Examples of such server devices are servers, mainframe computers, networked computers, a processor-based device, and similar types of systems and devices

What is claimed is:

1. A method of exchanging stored value for shopping at a vendor, comprising:
identifying, using a mobile computing device having a microprocessor, by an application on the mobile computing device a vendor for shopping by a user;
retrieving, using the mobile computing device, by the application information regarding a trade of stored value of the user issued by at least one other vendor in exchange for stored value issued by the vendor for shopping by the user;
identifying, using the mobile computing device, by the application at least a portion of the stored value of the user issued by the at least one other vendor to exchange for stored value issued by the vendor for shopping by the user; and
receiving, using the mobile computing device, by the application the stored value issued by the vendor for shopping by the user in exchange for at least a portion of the stored value of the user issued by the at least one other vendor.

2. The method of claim 1, wherein identifying the vendor for shopping by the user further comprises identifying by the application the vendor for shopping by the user using a user-locator function of the mobile computing device.

3. The method of claim 2, wherein identifying the vendor for shopping by the user using the user-locator function further comprises identifying by the application the vendor for shopping by the user using the user-locator function of the mobile computing device in communication with a vendor location database at a time when the mobile computing device is located at a premises of the vendor for shopping by the user.

4. The method of claim 3, wherein the user-located function further comprises a global positioning system function of the mobile computing device.

5. The method of claim 1, wherein identifying the vendor for shopping by the user further comprises receiving entry by the application of a selection of the vendor for shopping by the user.

6. The method of claim 5, wherein receiving entry by the application of the selection of the vendor for shopping by the user further comprises receiving entry by the application of the selection of the vendor for shopping by the user from a list of pre-designated preferred vendors of the user for shopping by the user.

7. The method of claim 1, wherein the application further comprises an application that is both web enabled and mobile enabled.

8. The method of claim 1, wherein the mobile computing device further comprises a mobile communication device.

9. The method of claim 8, wherein the mobile communication device further comprises a mobile phone.

10. The method of claim 1, wherein retrieving the information further comprises retrieving the information regarding the trade of stored value of the user issued by the at least one other vendor in exchange for stored value issued by the vendor for shopping by the user from a stored value exchange service.

11. The method of claim 1, wherein retrieving the information regarding the trade of stored value of the user further comprises retrieving the information regarding the trade of stored value of the user issued by a plurality of other vendors in exchange for stored value issued by the vendor for shopping by the user.

12. The method of claim 1, wherein retrieving the information regarding the trade of stored value of the user issued by the at least one other vendor further comprises retrieving information regarding a trade of at least one of a gift card, a prepaid card, or rewards points of the user issued by the at least one other vendor in exchange for stored value issued by the vendor for shopping by the user.

13. The method of claim 1, wherein retrieving the information regarding the trade of stored value of the user issued by the at least one other vendor further comprises retrieving at least a user's account identifier and a vendor's identifier with respect to the stored value of the user issued by the at least one other vendor.

14. The method of claim 1, wherein retrieving the information regarding the trade of stored value of the user issued by the at least one other vendor in exchange for the stored value issued by the vendor for shopping by the user further comprises retrieving a spend value of the stored value of the user issued by the at least one other vendor in an exchange for the stored value issued by the vendor for shopping by the user.

15. The method of claim 14, wherein retrieving the spend value of the stored value of the user further comprises retrieving a total spend value of the stored value of the user issued by a plurality of other vendors in an exchange for the stored value issued by the vendor for shopping by the user.

16. The method of claim 1, wherein identifying at least a portion of the stored value of the user issued by the at least one other vendor to exchange further comprises displaying on the mobile computing device a total spend value of the stored value of the user issued by a plurality of other vendors prioritized in a pre-determined order for an exchange.

17. The method of claim 16, wherein displaying the total spend value of the stored value of the user issued by the plurality of other vendors prioritized in the pre-determined order further comprises displaying on the mobile computing device the total spend value of the stored value of the user issued by the plurality of other vendors prioritized according to an exchange rate of each stored value in an exchange.

18. The method of claim 16, wherein displaying the total spend value of the stored value of the user issued by the plurality of other vendors prioritized in the pre-determined order further comprises displaying on the mobile computing device the total spend value of the stored value of the user issued by the plurality of other vendors prioritized according to an exchange value of each stored value in an exchange.

19. The method of claim 16, wherein displaying the total spend value of the stored value of the user issued by the plurality of other vendors prioritized in the pre-determined order further comprises displaying on the mobile computing device the total spend value of the stored value of the user issued by the plurality of other vendors prioritized according to a spend value of each stored value in an exchange.

20. The method of claim 16, wherein displaying the total spend value of the stored value of the user issued by the plurality of other vendors prioritized in the pre-determined order further comprises displaying on the mobile computing device the total spend value of the stored value of the user issued by the plurality of other vendors prioritized according to identification of each of the plurality of other vendors.

21. The method of claim 1, wherein receiving the stored value issued by the vendor for shopping by the user further comprises initiating via an exchange service a trade of at least a portion of the stored value of the user issued by at least one other vendor in exchange for the stored value issued by the vendor for shopping by the user.

22. The method of claim 1, wherein receiving the stored value issued by the vendor for shopping by the user further comprises displaying on the mobile computing device an identifier for the stored value issued by the vendor for shopping by the user.

23. The method of claim 22, wherein displaying the identifier further comprises displaying on the mobile computing device a scannable code for the stored value issued by the vendor for shopping by the user.

24. A system for exchanging stored value for shopping at a vendor, comprising:
a mobile computing device processor coupled to memory, wherein the mobile computing device processor is programmed for:
identifying by an application on the mobile computing device a vendor for a shopping by a user;
retrieving by the application information regarding a trade of stored value of the user issued by at least one other vendor in exchange for stored value issued by the vendor for shopping by the user;
identifying by the application at least a portion of the stored value of the user issued by the at least one other vendor to exchange for stored value issued by the vendor for shopping by the user; and
receiving by the application the stored value issued by the vendor for shopping by the user in exchange for at least a portion of the stored value of the user issued by the at least one other vendor.

25. A method of retrieving stored value for shopping at a vendor, comprising:
identifying, using a mobile computing device having a microprocessor, by a user-locator function of the mobile computing device a vendor for shopping by the user;
retrieving, using the mobile computing device, by an application on the mobile computing device of the user stored value of the user redeemable at the vendor for shopping by the user; and
displaying, using the mobile computing device, by an application on the mobile computing device of the user the retrieved stored value of the user redeemable at the vendor for shopping by the user.
